(19) United States
(12) Patent Application Publication
(10) Pub. No.: US 2014/0000922 A1
(43) Pub. Date: Jan. 2, 2014

(54) MULTIFUNCTIONAL PORTABLE ELECTRIC APPARATUSES

(71) Applicant: Roger PELLENC, Pertuis (FR)

(72) Inventor: Roger PELLENC, Pertuis (FR)

(73) Assignee: PELLENC (Société Anonyme), Pertuis (FR)

(21) Appl. No.: 13/955,562

(22) Filed: Jul. 31, 2013

Related U.S. Application Data
(63) Continuation-in-part of application No. 12/673,012, filed on Feb. 11, 2010, now abandoned.

(30) Foreign Application Priority Data
Sep. 6, 2007 (FR) 0706238

(51) Int. Cl. B25F 5/00

(52) U.S. Cl. CPC B25F 5/00
USPC 173/46

(57) ABSTRACT

The invention relates to portable electric apparatuses of the kind including a tool driven by an electric motor, and a battery supplying the electric power necessary for the operation of said tool, characterised in that said portable electric apparatuses include a communication system enabling, on the one hand, the exchange of information relative to the type, the state and the operation of the tool and of the battery when connected together and, on the other hand, the adjusting if need be of the operation parameters of said tool based on the characteristics of said battery and/or the operation parameters of the battery based on the operation parameters of said tool.

### CROSS-REFERENCE TO RELATED U.S. APPLICATIONS

The present application is a continuation-in-part of U.S. application Ser. No. 12/673012, filed on Feb. 11, 2010, and entitled “Multifunctional Portable Electric Apparatuses”, presently pending.

### STATEMENT RECORDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention deals with portable power tools of the type that feature, on the one hand, a tool including, an electric operating gear, and, on the other hand, a battery supplying the necessary energy for the functioning of this tool.

2. Description of Related Art Including Information Disclosed Under 37 CFR 1.97 and 37 CFR 1.98

The known portable power tools of this type include, on the one hand, a particular tool and its operating gear which are fitted for the execution of a specific job (for example: chainsaws, circular saws, small fruit stripping rakes, pruning scissors, lawn trimmers, brush cutters, pneumatic drills, etc.) and, on the other hand, a battery generating an electric current with tension and power characteristics which permit the normal functioning of said tool.

The operating parameters of the aforementioned batteries and different tools being specific to each application; it is not possible to obtain a satisfactory normal operation from these portable power tools by connecting any battery to any tool.

On the other hand, with the new generations of batteries and tools, it is necessary to constantly monitor the batteries, during their charging phase as well as during their discharge phase, in order to ensure safe operation and to obtain long life of said batteries. As a matter of fact, the batteries are subject to constraints with respect to their operation, safety and balancing of the elements during the charge, so that they need to be checked constantly, whereas their discharge parameters must be adapted to the tool being used.

It is also necessary to cheek the tools as well, in order to optimize their efficiency and their useful life. In fact, the tools must also have operating parameters which take into account the operating and safety constraints of the battery associated to them.

The document US-2000/0087285 describes a system of a portable power tool constituted by a battery, a tool and a charger. According to this document, there exists a communication from the battery to the tool, but there are no actions other than functional ones (in particular no modifications of the operating parameters of the tool). It is not envisaged that the tool might be a non-dedicated tool, chosen among a number of different tools.

The document US-2005/0048359 describes a battery (tool) charger system in which communication between the battery and the other elements of said system is provided in order to adjust the parameters of this battery or of the charger. In the case of communication with the tool, it is the battery which adapts its own operating parameters to the tool.

The two aforementioned documents present inadequacies, such as, for example, the impossibility of equipping the implements with non-dedicated tools the fixed operating parameters of which do not match the specific operating parameters of the battery that is being used. Another inadequacy is the impossibility of equipping the implements with non-dedicated batteries the operating parameters of which do not match the specific operating parameters of the tool that is being used.

Furthermore, the drive of these different tools may require the use of several batteries of different weights and space requirements.

In addition, the situation exposed above has some disadvantages including in case of malfunctioning, the users are not given any centralized information that would allow them to know the causes of the malfunctioning of their implements. When making the interventions of maintenance and customer service departments difficult and costly, again due to a lack of centralized information with respect to the usage of the implements.

It is the particular aim of the invention to provide a solution to the problems deriving from the aforementioned drawbacks or inadequacies.

### BRIEF SUMMARY OF THE INVENTION

According to the invention, this objective has been realized owing to portable power tools of the type featuring a tool (1) operated by an electric motor (2), this tool being a tool chosen among a number of different (non-dedicated) tools featuring their own operating parameters and their own code or means of identification, and a battery providing the energy necessary for the functioning of the chosen tool. Said portable power tools comprise a communication system configured so as to allow, on the one hand, an exchange of information relative to the type, condition and functioning of the tool and the battery that are connected to each other, and, on the other hand, to adapt, if need be, the operating parameters of said tool in relation to the characteristics of said battery and/or the operating parameters of the battery in relation, to the operating parameters of said tool.

Said communication system includes on the one hand, a control and command module of the tool, featuring an electronic board configured to transmit, to the battery, information relative to the type, condition and functioning of said tool. On the other hand, the system includes a control and management module of the battery, comprising an electronic board configured to transmit, to the tool, information relative to the type, condition and functioning of said battery.

According to another characteristic arrangement, the battery is a battery that has been chosen among a number of different non dedicated batteries with their own operating parameters and their own code or means of identification.

The invention provides several important advantages. It makes it possible in particular to identify the tool connected to the battery, to recognize the battery connected to the tool, to manage and adjust the operating parameters of the tool and the battery, for optimal efficacy, performance and useful life. In addition, it makes it possible to use, on the same battery, any tool chosen among a number of tools with different operating parameters or, more simply, to permit the use of different tools on the same battery; this possibility allowing an appreciable reduction of equipment costs relative to the current need to purchase portable power tools including a dedicated tool and a dedicated battery. Further, it makes it possible to use, for the operation of the same tool, any battery chosen among a number of batteries presenting different operating parameters, or, more simply, to allow the use of different batteries for the operation of the same tool; this capability offering, also the possibility of a sizable reduction of equipment costs relative to the current need to purchase portable power tools consisting of a dedicated battery and a dedicated tool. Next, it makes it possible to store the information provided by the tool and/or the battery and to give it back later on, during interventions by the maintenance or customer service departments for a more accurate and more efficient diagnosis. Finally, it makes it possible to transmit, in real time, information to the users, in case of any operating trouble, for example through an acoustic signal and/or a readout.

### BRIEF DESCRIPTION OF THE DRAWINGS

The above aims, characteristics and advantages and yet others will become clearer in the following description and the attached drawings in which:

FIG. 1 is an exploded perspective view of a production example of a portable power tool to which the invention can be applied, this apparatus comprising, according to this example, a tool including a portable chainsaw, a battery generating the energy required for the operation of this tool and an electric cord providing the wire connection between the battery and the tool and vice versa.

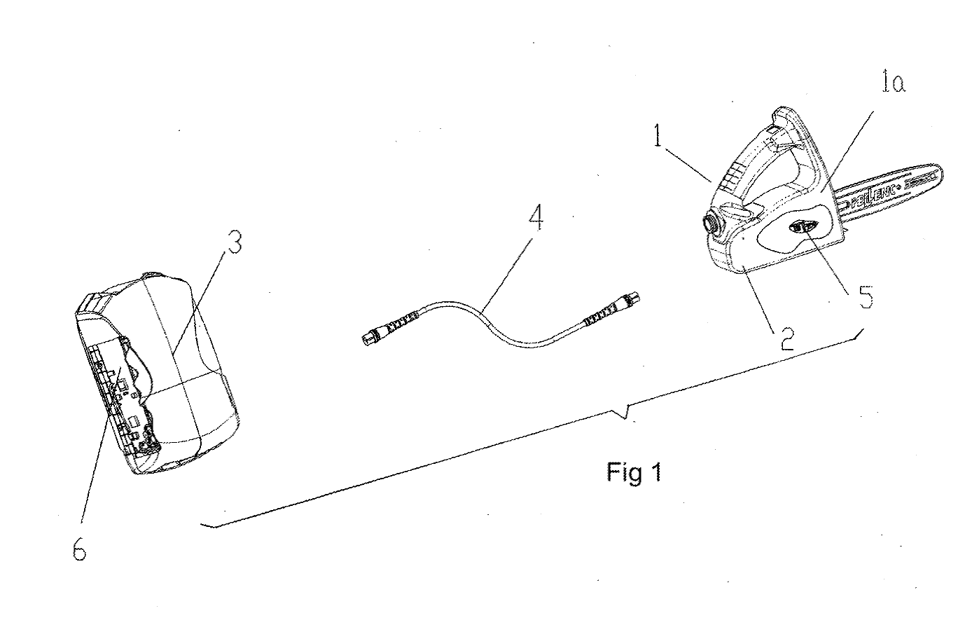

FIGS. 2A to 2E are isolated detail views, with partial pull-out, illustrating different production examples of the electric cord providing the wire connection between the battery and the portable power tools and vice versa.

FIGS. 3A to 3C are perspective views showing, by way of examples, various tools to which the invention can be applied.

Reference to said drawings is made to describe interesting although by no means limiting production examples of portable power tools according to the invention.

### DETAILED DESCRIPTION OF THE INVENTION

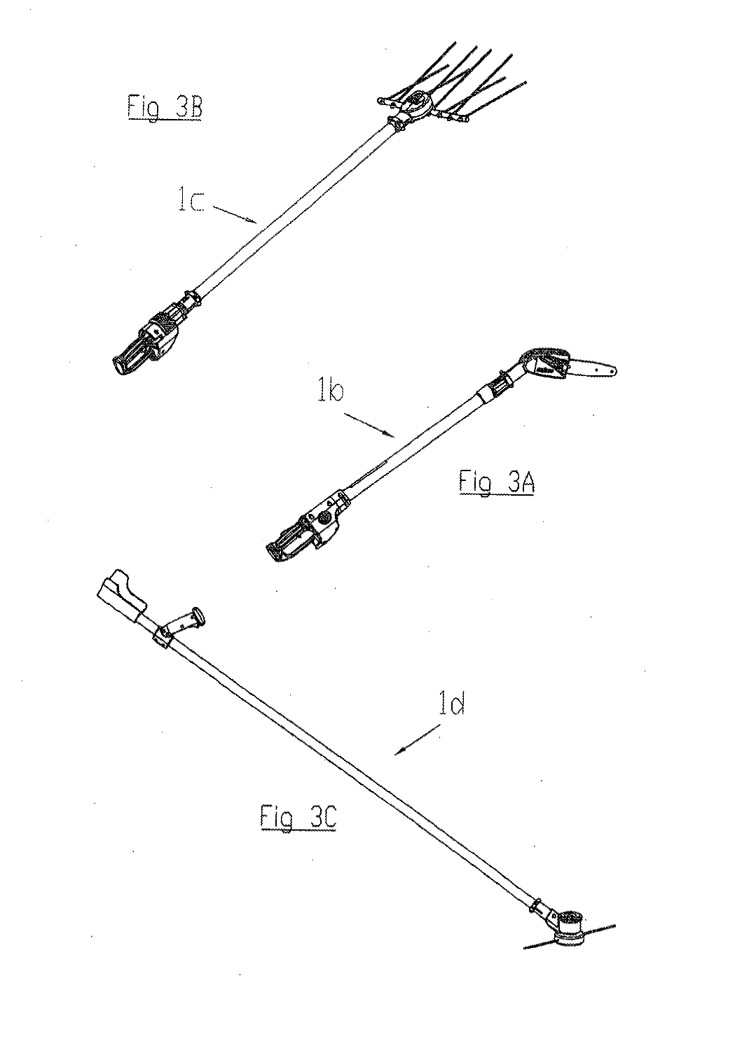

It is emphasized, that in the description which follows and in the claims, the term “portable power tool” designates portable assemblies comprising an electrically operated tool and a battery generating the electric energy required for the functioning of this tool. It is also to be noted that the term “different, non-dedicated tools” designates not only tools of the same type but operating with different operating parameters (for example chain saws 1a, of different power values), but also tools of different types, for example, a pole saw 1b (FIG. 3A), a small fruit stripping rake 1c (FIG. 3B), a brush mower 1d (3C). This list is not limiting. On the other hand, the term “different non-dedicated batteries” designates batteries with different operating parameters and not reserved for the operation of a tool with operating parameters which are its own.

The power tools to which the invention is applicable are of the type comprising, on the one hand, a tool 1 moved by an electric actuator 2 and, on the other hand, a battery 3 generating the energy required for the operation of this tool and which can be connected to the latter by an electric cable 4.

In a very advantageous manner and particularly aimed at by the opening, the tool 1 may be constituted by any tool chosen among, a number of different non-dedicated tools 1a, 1b, 1c, 1d, featuring their own operating parameters and their own code or means of identification, and/or the battery 3 may be constituted by any battery chosen among a number of different non-dedicated batteries featuring. their own operating parameters and their own code or means of identification.

Advantageously, the battery 3 supplying the energy required for the operation of the non-dedicated tools 1a, 1b, 1c, 1d, is a rechargeable lithium ion or lithium polymer battery, for example a battery of the kind described in the document WO-2005/053 915. In more general terms, it may be a lithium (Li) battery together with other metals or ternary compounds. such as, for example, lithium-iron (Li-Fe-Po-4), lithium manganese, lithium cobalt, lithium-ternary alloy (Li, Mn-Ni, Co-O2), etc.

According to another characteristic arrangement, the communication system includes on the one hand, a control and command module of tool 1, including a configured electronic board 5 to transmit, to battery 3, information relative to the type, condition and operation of said tool, and, on the other hand, a control and management module of battery 3, including a configured electronic board 6 to transmit, to the tool, information relative to the type, condition and operation of said battery.

According to another characteristic arrangement, the portable power tools according to the invention include a communication system which allows, on the one hand, an exchange of information relative to the type, condition, and the operation of tool 1 and of battery 3 which are connected to each other, and, on the other hand, to adapt, as needed, the operating parameters of said too/ depending on the characteristics of said battery and/or the operating parameters of the battery depending on the operating parameters of said tool.

According to another characteristic arrangement, the tool 1 has a code or a means by which it can be identified by the battery. The battery 3 is equipped with a means or system of recognition of this code and/or of this means of identification and this means of recognition being activated or identified as soon as it [the battery] is electrically connected to tool 1. The battery 3 has a code and/or means whereby it can be identified by the tool. The tool 1 is equipped with a means or system of recognition of the battery, this means of recognition being activated or identified as soon as said tool is electrically connected to the latter.

Owing to the recognition and communication systems according to the invention, each tool can send to the battery information which can be read and anal zed by it [the battery], for example in the form of a series of current and/or voltage variations, preferably according to a binary mode. constituting its identification code to be recognized by said battery and/or information on the operating parameters which are particular to it;

Each battery can send to the tool information which can be read and analyzed by the tool for example in the form of a series of current and/or voltage variations, preferably according to a binary mode, constituting its identification code to be recognized by said tool and/or information on the operating parameters which are particular to it.

On the other hand, this communication system allows managing and adjusting the operating parameters of the tool and of the battery (for example: safety, current and temperature threshold alarm), for optimal efficacy, performance and useful life.

According to another characteristic arrangement, the electronic control board of the tool and/or the electronic management boards of the battery is or are configured to store the information emitted by the tool and/or by the battery while the power tools are being used, and to eventually give back this information, so as to permit its processing by the maintenance and repair departments.

According to another characteristic and interesting arrangement, the electronic control board of the tool and/or the electronic management board of the battery is or are configured to send, in real time, information to an indicating system equipping the power tools in the event of operational trouble with the components of the latter, this indicating system consisting perhaps of an audible alarm device, a blinking light, a readout, etc.

Preferably, the electronic control board of the tool and/or the electronic management boards of the battery are configured so that the information exchanges between the tool and the battery are governed by the electronic control and command module of the tool. In this case, it is the tool which is master of the communication and which requests information from the battery at the start-up of the tool, and during the operation of the power tool, at regular intervals the battery listening constantly, to receive, analyze and treat at any time the information communicated by the tool.

According to another characteristic arrangement, the interface between the tool and the battery is provided by a wire connection.

According to another execution mode, the information exchange between the battery and the tool and vice versa, is performed by a wireless connection.

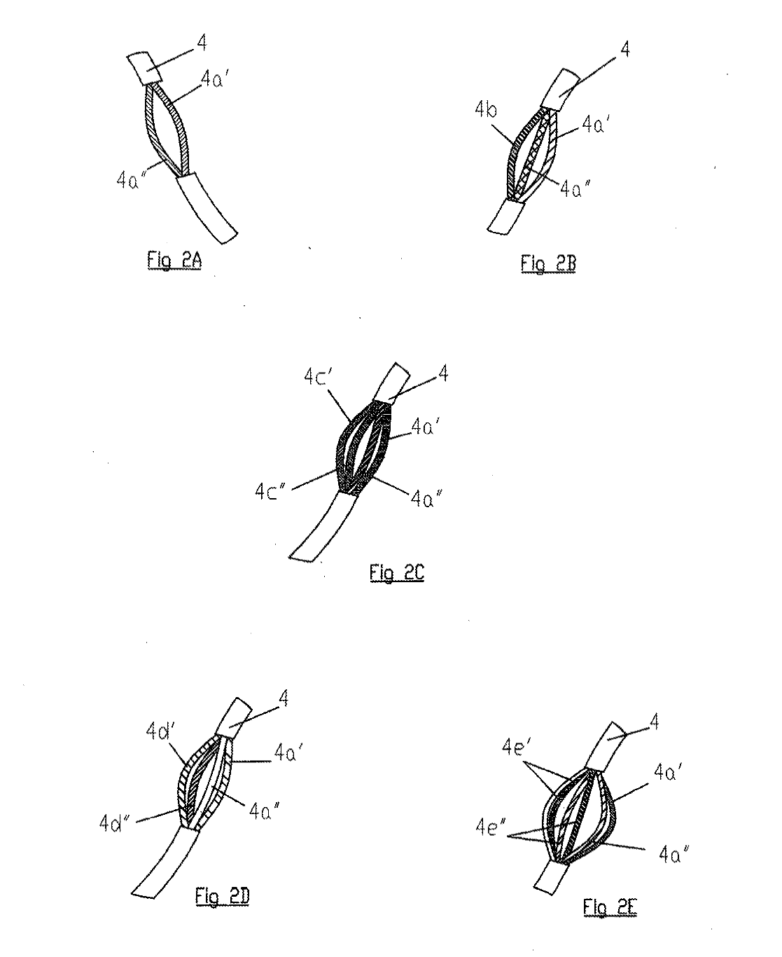

The wire connection permitting the exchange of information between the battery and the tool may be executed in various ways. For example, communication by means of power conductors 4a′, 4a″, from the tool to the battery or from the battery to the tool (FIG. 2A) by means of one of the following techniques carrier currents; modulation of the supply voltage; analysis of the consumption currents of the tool and/or of the voltage evolution of the battery, connection, in digital mode, by means of a single dedicated conductor 4b, referenced at 0 Volt and of levels 0/5 V, for example permitting a bidirectional communication between the tool and the battery (FIG. 2B); connection, in rhythmic mode, or in differential mode, through the intermediary of two dedicated conductors 4c′, 4c″, referenced at 0 Volt, one for the communication of the tool to the battery and one for the communication of the battery to the tool (FIG. 2C); connection, in digital mode, through the intermediary of two dedicated conductors 4d′, 4d″, referenced at 0 Volt, one for the communication tool to battery and one for the communication battery to tool (FIG. 2D) connection, in differential mode, through the intermediary of four dedicated conductors, referenced at 0 Volt, two (4e′) for the communication tool to battery and two (4e″) for the communication battery to tool (FIG. 2E).

Different modes of wireless connections between the battery and the tool may be put to work to realize an exchange of information between these two components of the power tools, for example: fiber optic link (infrared rays); radio relay link; links by IRDA, or WIFI, or BLUETOOTH, or ZIGBEE systems, etc. These different modes of communication having their specific protocols and application software.

I claim:

1. An apparatus comprising:
a tool driven by an electric motor, said tool having a plurality of operating parameters and an identification code, said tool being, a non-dedicated tool;
a battery electrically connected to said tool so as to supply power to said tool said battery having a plurality of characteristics and a plurality of operating parameters;
a control and command module having an electronic board having information relative to a type of said tool and a condition of said tool and a functioning of said tool;
a control and management module affixed to said battery, said control and management module having information relative to a type of said battery and a condition of said battery and a functioning of said battery; and
a communicating means for transmitting the information of said tool to said control and management module of said batters and for transmitting the information of said battery to said control and command module of said tool so as to adapt the plurality of operating parameters of said tool to the plurality of characteristics of said battery and so as to adapt the plurality of operating parameters of said battery to the plurality of operating parameters of said tool.

2. The apparatus of claim 1, said battery being a non-dedicated battery having an identification code.

3. The apparatus of claim 1, the apparatus further comprising:
a means for recognizing the identification code of said tool by said control and management module of said battery as soon as said battery is connected to said tool.

4. The apparatus of claim 1, said battery having an identification code, the apparatus further comprising:
a means for recognizing the identification code of said battery by said control and command module of said tool as soon as said tool is connected to said battery.

5. The apparatus of claim 1, said battery being a lithium battery.

6. The apparatus of claim 1, said control and command module of said tool and said control and management module of said battery being configured to store the information of said tool and the information of said battery while said tool is in operation.

7. The apparatus of claim 1, said electronic hoard of said control and command module of said tool configured such that the transmitting of the information by said communication means is governed by said control and command module of said tool.

8. The apparatus of claim 1, said communicating means being a wire connection.

9. The apparatus of claim 8, said wire connection comprising a plurality of power conductors extending between said tool and said battery.

10. The apparatus of claim 8, said wire connection comprising a single digital conductor referenced at 0 volts and operating at between 0 to 5 volts.

11. The apparatus of claim 8, said wire connection comprising a pair of conductors operating rhythmically and referenced at 0 volts, one of said pair of conductors communicating from said tool to said battery, the other of said pair of conductors communicating from said battery to said tool.

12. The apparatus of claim 8, said wire connection comprising a first digital conductor and a second. digital conductor each referenced at 0 volts, said first digital conductor communicating, from said tool to said battery, said second digital conductor communicating from said battery to said tool.

13. The apparatus of claim 8, said wire connection comprising four conductors referenced at 0 volts, two of said four conductors-communicating from said tool to said battery, the other two of said our conductors communicating from said battery to said tool.

14. The apparatus of claim 8, said wire connection being a fiberoptic line.
